(19) United States
(12) Patent Application Publication
(10) Pub. No.: US 2003/0121400 A1
(43) Pub. Date: Jul. 3, 2003

(54) Portable hand-held music synthesizer method and apparatus

(75) Inventor: Andrew T. Wilson, Portland, OR (US)

Correspondence Address: MARGER JOHNSON & McCOLLOM, P.C., 1030 S.W. Morrison Street, Portland, OR, 97205, US

(73) Assignee: Intel Corporation, Santa Clara, CA (US)

(21) Appl. No.: 10/040,867

(22) Filed: Dec. 27, 2001

(51) Int. Cl. G10H 1/26

(52) U.S. Cl. 84/609

(57) ABSTRACT

The apparatus involves a hand-held housing with a memory for storing coded audio event data, a mechanism for downloading into the memory coded audio event data and digital-audio electronics for retrieving coded audio event data from memory, converting it to an audio signal and playing it out. The data preferably is stored in accordance with a musical instrument digital interface (MIDI) standard, and may be created on an appropriately equipped personal computer (PC). The capacity of such a hand-held device is far greater than if the data were conventionally digitized or coded.

### BACKGROUND OF THE INVENTION

The invention relates generally to portable digital audio play-out devices. More particularly, it concerns the provision of high-quality, high-volume digital audio file format compatible with downloading music to a portable hand-hand held device.

Portable MP3 players such as the Intel PocketConcert™ player provide a convenient way to transport music while traveling. However, even the best-known methods of audio compression, e.g. MP3, still produce extremely large files. For example, an hour of music compressed to 128 kilobits/sec (kbps) with MP3 occupies approximately 64 megabytes (MB) of memory. Such a large memory requirement limits range of access to portable music and for many is prohibitively expensive.

PCM audio, e.g. audio CDs or WAV files, are created by sampling a continuous audio signal and recording the amplitude in digital form. Those of skill in the art will appreciate that such a recording format is very data intensive and requires very high-bandwidth (e.g. 1.2 megabits/second (1.2 Mbps) data input/output (I/O) and data processing pathways and proportionately very high-capacity memory storage.

Conventional portable MP3 or Windows Media players and music synthesizer programs on desktop personal computers (PCs) transform time-domain PCM signals into frequency-domain audio data and then compress the data to eliminate inaudible frequency ranges. Such compressed-audio data files nevertheless require high-bandwidth processing (e.g. 128 kbps) and proportionately high-capacity memory storage. With desktop PCs, such large memory requirements are more easily met than with hand-held portable or pocket devices such as personal digital assistants (PDAs) or so-called pocket PCs. Those of skill in the art will appreciate that, the larger the memory, the more substantial the power requirement. Thus, large memories required to store even compressed, e.g. MP3, high-fidelity music-representative data in hand-held portable devices, also decrease useful battery life, which remains at a premium despite continuous developments in battery technology.

The musical instrument digital interface (MIDI), an existing music industry standard, is a common interface option on many desktop PCs. It provides a coding standard for synthesizing and recording musical events, e.g. note on, note off, attack, delay, pan, etc. Familiarity by those of skill in the art with the MIDI standard is assumed. Generally, the MIDI format is considered a compressed format because it does not require synthesis or storage of each and every nuance of continuous voice, pitch, duration, volume and envelope quality of a musical note, beat, phrase, score or lyric. Essentially, it is represents a computerized version, or coded, musical score that defines only musical events and their sequence, thereby significantly reducing the overhead of such detailed, high-bandwidth audio sampling and recording techniques. Typically, a MIDI file requires only approximately 12 kbps in bandwidth and proportionately smaller memory storage capacity.

Accordingly, wider access to music synthesis in a convenient, portable format combined with compressed audio playback capability is desired.

### BRIEF DESCRIPTION OF THE DRAWINGS

FIG. 1 is a system block diagram of the invented pocket music synthesizer in accordance with an embodiment of the invention, connected to a conventional desktop personal computer (PC).

FIG. 2 is a detailed schematic diagram of the pocket music synthesizer of FIG. 1.

FIG. 3 is a flowchart illustrating the invented method in accordance with an embodiment thereof.

### DETAILED DESCRIPTION

Those of skill in the art will appreciate that an MP3 or other compressed audio file typically stores multiple digitized waveform patterns at a given high resolution, the patterns representing continuous and continuously changing musical characteristics as pitch, volume, envelope duration, attack, decay, etc. Such files are high-resolution digital representations of actual sounds, and, as such, may be understood to require high-volume storage and high-bandwidth signal processing. Audio players using such audio file formats thus are characterized by greater physical size, power draw and cost and lower capacity and thus versatility.

Those of skill in the art will appreciate that a MIDI file stores only a sequence of coded musical events (notes, volumes, rhythm patterns) needed to create the piece. A MIDI score therefore occupies orders of magnitude (e.g. presently nearly two orders of magnitude) less space than even compressed audio. A 128 MB portable hand-held music synthesizer could hypothetically hold 100 hours or more of MIDI music. Intermixing MIDI tracks with MP3 tracks would give effective playing time somewhere between two hours (MP3 only) and 100 hours (MIDI only), depending upon the mix of formats. Those of skill in the art will appreciate that this mix may be user-selectable, thereby further personalizing use of the invented apparatus.

The present invention allows a user to create and arrange MIDI files on a desktop PC, and to download them and play them on a portable device. One embodiment of such a system would include one or more of the following features:

a) a portable, battery-powered audio player device with an on-board reduced instruction set computer (RISC) processor or digital signal processor (DSP);

b) a re-writable storage, e.g. flash memory, microdrive, mini-optical disc. etc. for storing MIDI files in the device;

c) a method for downloading files to the device from a desktop PC, whether wired (Universal Serial Bus (USB), FireWire) or wireless (Bluetooth, ITTC 802.11);

d) on-device MIDI synthesizer software with fixed or rewritable instrument banks;

e) front-panel video-game type hand controls on the device facilitating user selection of musical volume and track selection (i.e. operational modes) elements of music synthesis during playback, e.g. tempo, expressiveness, looping, “funk,” etc. (i.e. musical modes);

f) software in the PC for creating, editing, and downloading MIDI scores and voices to the device; and

g) an ability also to play back MP3 or other compressed audio formats on the portable device and to intermix compressed audio files with MIDI files on playlists.

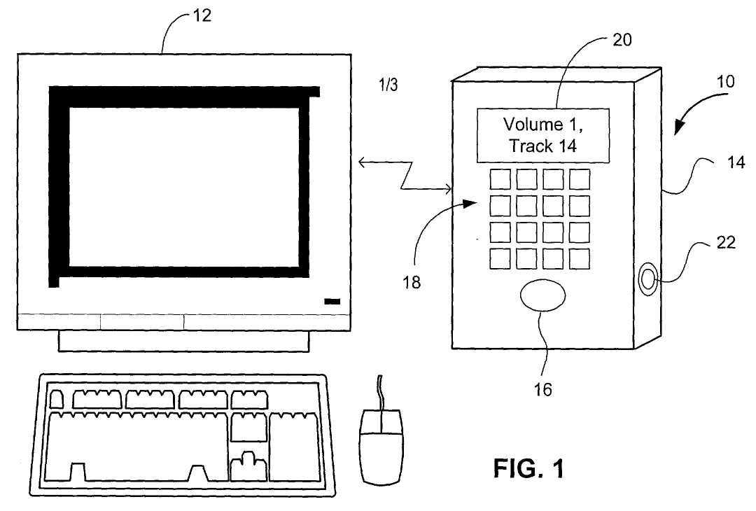

FIG. 1 shows the invented apparatus 10 in accordance with one aspect of the invention, in system block diagram form, operatively connected, e.g. via a wireless communication mechanism, with a conventional desktop personal computer (PC) 12. Apparatus 10 will be understood to be lightweight and portable, e.g. hand-held, and to include a housing 14, a thumbpad 16, a keypad 18, a display 20 and a stereo headphone jack 22. Thumbpad 16 and keypad 18 will be referred to herein as front panel controls, or simply, user controls.

User controls 16, 18 may include any customized key cluster, including game pad-like controls such as finger- and/or thumb-actuated fire buttons, hat switches and traditional keypads. As is known, hat switches may be analogue in nature, e.g. they may be pressure-sensitive and highly responsive to user inputs. Such switches may be used for expression, pace and/or volume control. Thus, a user of apparatus 10 may enjoy ease and precision of control of musical sources to be played out, as well as of browsing and selection of musical albums and/or tracks.

Those of skill in the art familiar with pocket PCs will appreciate that housing 14 contains electronics to be described that permit user key entry via the front panel controls and feedback via display 20, which, for example, may display the current musical selection, as illustrated. Those of skill also will appreciate that the musical selection may be rendered audible to the user of apparatus 10 by use of a speaker or stereo headphone (not shown). Finally, those of skill will appreciate that musical selections may be downloaded from remote PC 12 into a memory within apparatus 10 on demand by the user, with PC 12 having been used to create what will be referred to herein as coded audio event data.

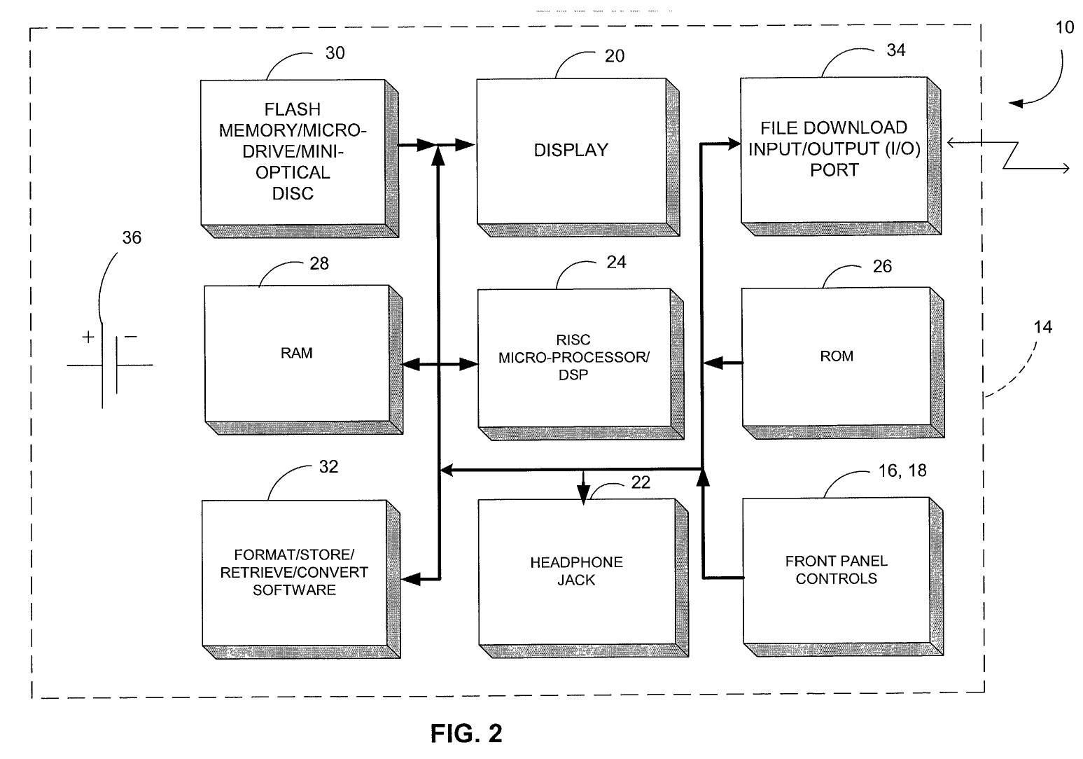

FIG. 2 shows apparatus 10 in simplified schematic block diagram form. Apparatus 10 within housing 14 may be seen to include externally accessible and visible front panel controls (thumbpad 16 and keypad 18), display 20 and headphone jack 22. The other blocks within apparatus 10 include a digital microprocessor, e.g. a RISC processor or digital signal processor (DSP) 24; a read-only memory (ROM) 26; a random-access memory (RAM) 28; a high-speed, high-capacity non-volatile memory (e.g. a flash memory, a micro-drive or mini-optical disk) 30; a software program 32 adapted to synthesizing an analogue audio signal by converting or decoding the coded audio event data; a file download input/output (I/O) port 34; and a battery 36.

Those of skill in the art will appreciate that the processor, memory and/or conversion functions may be differently configured, within the spirit and scope of the invention. Those of skill also will appreciate that the hand-held device and its display and control functions may also be differently configured, within the spirit and scope of the invention. The software and firmware functions and the user interface itself straightforwardly may be implemented using known development tools, operating systems and applications programs.

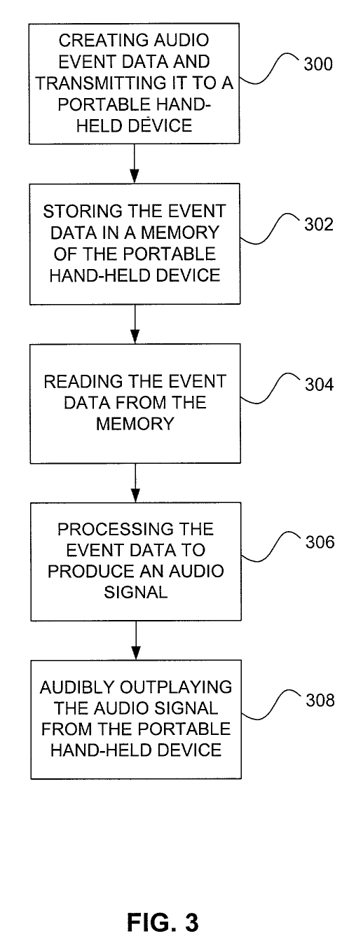

FIG. 3 illustrates the invented method of the invention in the form of a simplified flowchart. At 300, audio event data is created and transmitted to a hand-held device. At 302, the event data is stored in a memory of the portable hand-held device. (It will be appreciated that, typically, the event data is downloaded, e.g. from a remote PC or other processor, to the hand-held device. Such may be accomplished by any suitable means, e.g. via infrared, radio-frequency (RF) transmission or other wireless means such as Bluetooth, ITTC 802.11, etc., or via a wired interface such as USB, FireWire, etc.) At 304, the event data is read from the memory. At 306, the event data is processed to produce an audio signal. Finally, at 308, the audio signal is audibly outplayed from the portable hand-held device. It will be appreciated by those of skill in the art that the process blocks are performed or assisted by software or firmware executing in a microprocessor or DSP or external PC or other external processor. For example, processing block 306 may be performed by software program 32 (see FIG. 2) stored as a series of instructions residing in RAM 28 and executing in RISC processor/DSP 24.

One drawback to synthesis is that, while current methods of music synthesis are capable of recreating instrumental sounds with excellent musical quality, they are not yet capable of synthesizing broadband vocals with high musical quality. Nevertheless, prospective buyers of the invented device might be older and more interested in personal expression and music creation than are typical purchasers of MP3. And of course advances in the capabilities of formatting, storing, retrieving, converting and playing out coded audio event data are expected to improve, as MIDI and alternative formats are further developed.

The portable hand-held music synthesizer apparatus would extend a supplier's audio product line by adding a high-tech capability not found in conventional MP3 players. It is a natural extension to desktop PC applications software, since scoring, arranging and editing MIDI music require a desktop PC. Such a desktop PC may include an installed base of music programs, e.g. SonicFoundry Acid™, which lets a user create professional-sounding MIDI files. The invention makes it possible conveniently and inexpensively to transport anywhere a large personal musical library.

Finally, those of skill in the art will appreciate that the invented method and apparatus described and illustrated herein may be implemented in software, firmware or hardware, or any suitable combination thereof. Preferably, the method and apparatus are implemented in a combination of the three, for purposes of low cost and flexibility. Thus, those of skill in the art will appreciate that the method and apparatus of the invention may be implemented by a computer or microprocessor process in which instructions are executed, the instructions being stored for execution on a computer-readable medium and being executed by any suitable instruction processor. Alternative embodiments are contemplated, however, and are within the spirit and scope of the invention.

Having described and illustrated the principles of the invention in a preferred embodiment thereof, it should be apparent that the invention can be modified in arrangement and detail without departing from such principles. I claim all modifications and variation coming within the spirit and scope of the following claims.

1. Apparatus for synthesizing audio scores, the apparatus comprising:
a housing of approximately hand-held size;
a memory within said housing for storing coded audio event data;
a mechanism for downloading into said memory coded audio event data; and
digital-audio electronics within said housing for retrieving coded audio event data from said memory, for converting said coded audio event data into an audio signal and for playing out said audio signal audibly to a user of said device.

2. The device of claim 1, wherein said mechanism for downloading operates wirelessly.

3. The device of claim 1, wherein said mechanism for downloading includes a personal computer (PC) operated remotely from said device and wherein said means for downloading operates wirelessly.

4. The device of claim 1 in which the coded audio event data is stored in accordance with a musical instrument digital interface (MIDI) standard.

5. The device of claim 1 which further comprises:
one or more user controls on said housing, the user control enabling the user to selectively out-play said audio signal.

6. The device of claim 5, wherein said user controls enable the user to select musical event data from one or more audio tracks for out-play of said audio signal from a library containing plural audio tracks.

7. The device of claim 5, wherein said user controls enable the user to select a mode in which the out-play of the audio signal occurs.

8. The device of claim 7, wherein the mode of out-play includes one or more operational modes.

9. The device of claim 7, wherein the mode of out-play includes one or more musical modes.

10. The device of claim 5, wherein the user control includes a thumb-operable multi-directional pressure-sensitive switch.

11. The device of claim 10, wherein the hat switch and the electronics are configured to enable a user to select one or more modes in which the out-play of the audio signal occurs, and wherein the modes include one or more of expression, pace and volume.

12. The device of claim 5 which further comprises:
a display on said housing, the display enabling a user to visually monitor the selective out-play of said audio signal.

13. A method of storing for synthesis and out-play coded audio event data recordings in a portable hand-held device, the method comprising:
storing coded audio event data in a memory contained within a portable hand-held device;
reading said coded event data from the memory;
processing said coded event data to produce an audio signal represented by said coded event data; and
audibly out-playing said audio signal from the portable hand-held device.

14. The method of claim 13, wherein said storing, reading and processing is of coded audio event data formatted in accordance with a musical instrument digital interface (MIDI) standard.

15. The method of claim 14 which further comprises, prior to said storing:
creating the coded audio event data on a remote processor.

16. The method of claim 14, wherein the remote processor is a personal computer (PC).

17. The method of claim 15 which further comprises, after said creating and prior to said storing:
downloading the coded audio event data from the remote processor to the hand-held device.

18. An article of manufacture for use with a portable hand-held device for storing for synthesis and out-play of coded audio event data recordings, the article comprising a computer-readable medium containing a program, the program comprising:
storage firmware for storing coded audio event data in a memory contained within the portable hand-held device;
access firmware for reading the coded event data stored in the memory;
processor firmware for processing the coded event data read from memory to produce an audio signal represented by the coded event data; and
out-play firmware for audibly outplaying the audio signal from the portable hand-held device.

19. A computer-readable medium containing a program according to claim 16, wherein the program further comprises:
download firmware for downloading the coded event data to the portable hand-held device from a remote processor.

20. A portable hand-held apparatus for synthesizing audio scores, the apparatus comprising:
a mechanism for storing coded audio event data in a memory contained within a portable hand-held device;
a mechanism for reading the coded event data stored in the memory;
a mechanism for processing the coded event data read from the memory to produce an audio signal represented by said coded event data; and
a mechanism for audibly out-playing said audio signal from the portable hand-held device.

21. The apparatus of claim 20 which further comprises:
a mechanism for downloading the coded event data to the portable hand-held device from a remote processor.
